(19) United States
(12) Patent Application Publication
(10) Pub. No.: US 2016/0259978 A1
(43) Pub. Date: Sep. 8, 2016

(54) METHOD AND APPARATUS FOR DETECTING HARMFUL VIDEO

(71) Applicant: ELECTRONICS AND TELECOMMUNICATIONS RESEARCH INSTITUTE, Daejeon (KR)

(72) Inventors: Chi-Yoon JEONG, Daejeon (KR); Seung-Wan HAN, Daejeon (KR)

(21) Appl. No.: 15/058,827

(22) Filed: Mar. 2, 2016

(30) Foreign Application Priority Data
Mar. 3, 2015 (KR) 10-2015-0030019

(51) Int. Cl. G06K 9/00; G06K 9/62

(52) U.S. Cl. CPC G06K 9/00718; G06K 9/6227

(57) ABSTRACT

A method and apparatus for detecting a harmful video is provided. The apparatus includes an image collection unit configured to sample a video which is input, and collect N image frames (a natural number larger than or equal to 2) every predetermined period; an image analysis unit including M (a natural number larger than or equal to 2) analyzers, each analyzer analyzing a different characteristic of an image for determining harmfulness of the video; a scheduler configured to determine a plurality of analyzers for analyzing the collected N image frames among the M analyzers, and allocate at least one among the N image frames to each of the plurality of determined analyzers; and a harmfulness determination unit configured to integrate analysis results of the plurality of determined analyzers and determine the harmfulness of the video.

### CROSS-REFERENCE TO RELATED APPLICATION

This application claims priority to and the benefit of Korean Patent Application No. 2015-0030019, filed on Mar. 3, 2015, the disclosure of which is incorporated herein by reference in its entirety.

### BACKGROUND

1. Field of the Invention

The present invention relates to a method and apparatus for detecting a harmful video, and more particularly, to a method and apparatus for effectively detecting a harmful video by selectively applying a plurality of analyzers analyzing the harmful characteristic of streaming video data which is input in real time.

2. Discussion of Related Art

Due to the rapid spread of smart phones, streaming services for watching videos in real time through internet is increasing explosively. The streaming service, the best known of which is YouTube, has the advantage being able to watch a video at a desired time and a desired location, but has the disadvantage in that adolescents can easily access a harmful video. A method of determining harmfulness of a conventional streaming video determines the harmfulness of images by determining the harmfulness of the sequential images, accumulating the determination results, and determining that the video is harmful when the accumulated value of the results is equal to or more than a predetermined threshold value. Since for the streaming data tens of frames are reproduced per second, back to back images which are continuously input for analyzing harmfulness are very similar. Accordingly, when using the conventional method as is, since the image harmfulness on similar image data is continuously determined, there was a problem of hogging the system resource. Further, when the same image similarity analyzer is used on similar data, there is a problem in which an error is repeatedly accumulated when error detection is generated once.

Background technology of the present invention is disclosed in Korean Patent Publication No. 10-2009-0057596 (2009. 06.08).

### SUMMARY OF THE INVENTION

The present invention is directed to a method and apparatus capable of effectively detecting a harmful video even in a system having a low processing capability by selectively applying analyzers, which analyze various image characteristics, to a video when determining the harmfulness of the video.

According to one aspect of the present invention, there is provided an apparatus for detecting a harmful video, including: an image collection unit configured to sample an input video and collect N image frames (a natural number larger than or equal to 2) every predetermined period; an image analysis unit including M (a natural number larger than or equal to 2) analyzers, each analyzer analyzing a different image characteristic for determining harmfulness of the video; a scheduler configured to determine a plurality of analyzers for analyzing the collected N image frames among the M analyzers and allocate at least one among the N image frames to each of the plurality of determined analyzers; and a harmfulness determination unit configured to integrate analysis results of the plurality of determined analyzers, and determine the harmfulness of the video.

The scheduler may determine the plurality of analyzers for analyzing the collected N image frames based on a characteristic of each analyzer.

The scheduler may determine the plurality of analyzers for analyzing the collected N image frames based on the video and at least one piece of information related to the collected N image frames.

The scheduler may determine the plurality of analyzers for analyzing characteristics of the collected N image frames based on the result of monitoring the resource of the system.

According to another aspect of the present invention, there is provided a method for detecting a harmful video, including: sampling a video, and collecting N image frames (a natural number larger than or equal to 2) every predetermined period; determining a plurality of analyzers for analyzing the collected N image frames among M (a natural number larger than or equal to 2) analyzers, each analyzer analyzing a different characteristic of an image for determining harmfulness of the video; allocating at least one among the N image frames to each of the plurality of determined analyzers; and integrating analysis results of the plurality of determined analyzers and determining the harmfulness of the video.

### BRIEF DESCRIPTION OF THE DRAWINGS

The above and other objects, features and advantages of the present invention will become more apparent to those of ordinary skill in the art by describing in detail exemplary embodiments thereof with references to the accompanying drawings, in which:

FIGS. 1A and 1B are diagrams for describing a concept of analyzer scheduling according to an embodiment of the present invention;

FIG. 2 is a block diagram illustrating an apparatus for detecting a harmful video according to an embodiment of the present invention;

FIG. 3 is a diagram for describing an operation determining an analyzer in a scheduler according to an embodiment of the present invention;

FIG. 4 is a flowchart for describing a method of detecting a harmful video according to an embodiment of the present invention;

FIG. 5 is a flowchart for describing a method of determining harmfulness of a video by scheduling analyzers based on a round-robin method according to one embodiment of the present invention;

FIG. 6 is a flowchart for describing a method of determining harmfulness of a video by scheduling analyzers based on monitoring result of system resource according to another embodiment of the present invention; and

FIG. 7 is a flowchart for describing a method of determining harmfulness of a video by scheduling analyzers based on a system resource which is usable in real time according to still another embodiment of the present invention.

### DETAILED DESCRIPTION OF EXEMPLARY EMBODIMENTS

While the present invention is shown and described in connection with exemplary embodiments thereof, it will be apparent to those skilled in the art that various modifications and equivalent and alternative forms can be made without departing from the spirit and scope of the invention. In the following description with respect to embodiments of the present invention, when a detailed description of known functions or configurations related to the present invention unnecessarily obscures the gist of the present invention, a detailed description thereof will be omitted. The articles “a,” “an,” and “the” are singular in that they have a single referent, but the use of the singular form in the present document should not preclude the presence of more than one referent.

Hereinafter, exemplary embodiments of the present invention will be described in detail below with reference to the accompanying drawings. In the following description of the present invention, the same reference numerals are used for the same or corresponding components, and a duplicated description thereof will be omitted.

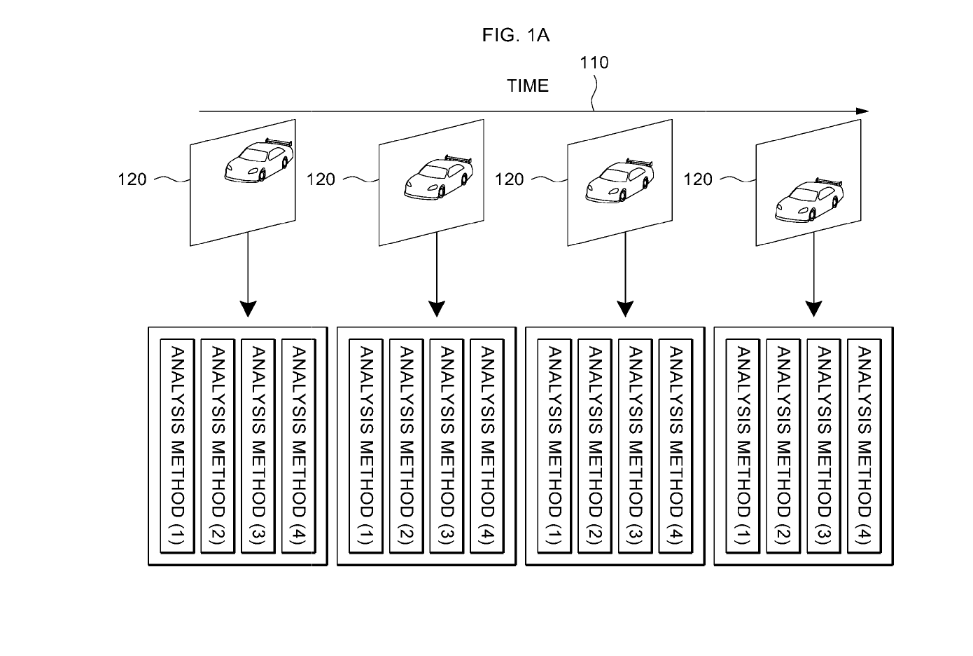

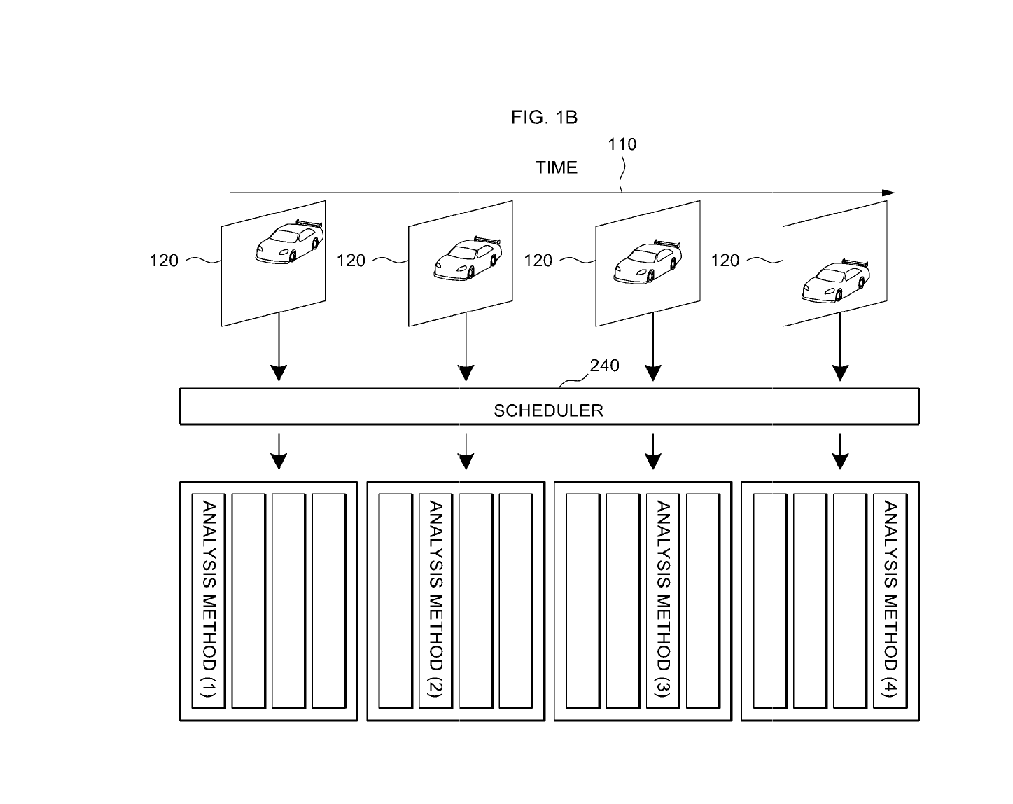

FIGS. 1A and 1B are diagrams for describing a concept of multiple analysis scheduling according to an embodiment of the present invention.

Referring to FIG. 1A, a conventional analysis scheduling method is illustrated. As shown in FIG. 1A, the conventional analysis scheduling method detects harmfulness of an image by applying an analyzer analyzing four different image characteristics to each of four consecutive images 120 every predetermined period 110. However, a streaming video has the image overlapping characteristic in which contents of consecutive images are not greatly changed. Considering the overlapping of the images, the present invention proposes a method of selectively applying an analyzer to each of the images as shown in FIG. 1B.

From the point of view the results of the harmfulness determination, when the content of each of the consecutive images is not greatly changed, the harmfulness analysis result shown in FIG. 1A and the harmfulness analysis result shown in FIG. 1B are almost the same. When the content of each of the consecutive images is not greatly changed, effects of simultaneously applying N analyzers may be obtained by integrating N analyses results of a single analyzer applied to the input images along the time axis, that is, in time. Meanwhile, when selectively applying the analyzer instead of simultaneously applying the N analyzers to the input image, since the amount of operations is considerably reduced, the harmfulness of the streaming video may be efficiently determined even by a smart terminal, etc. having low processing capability.

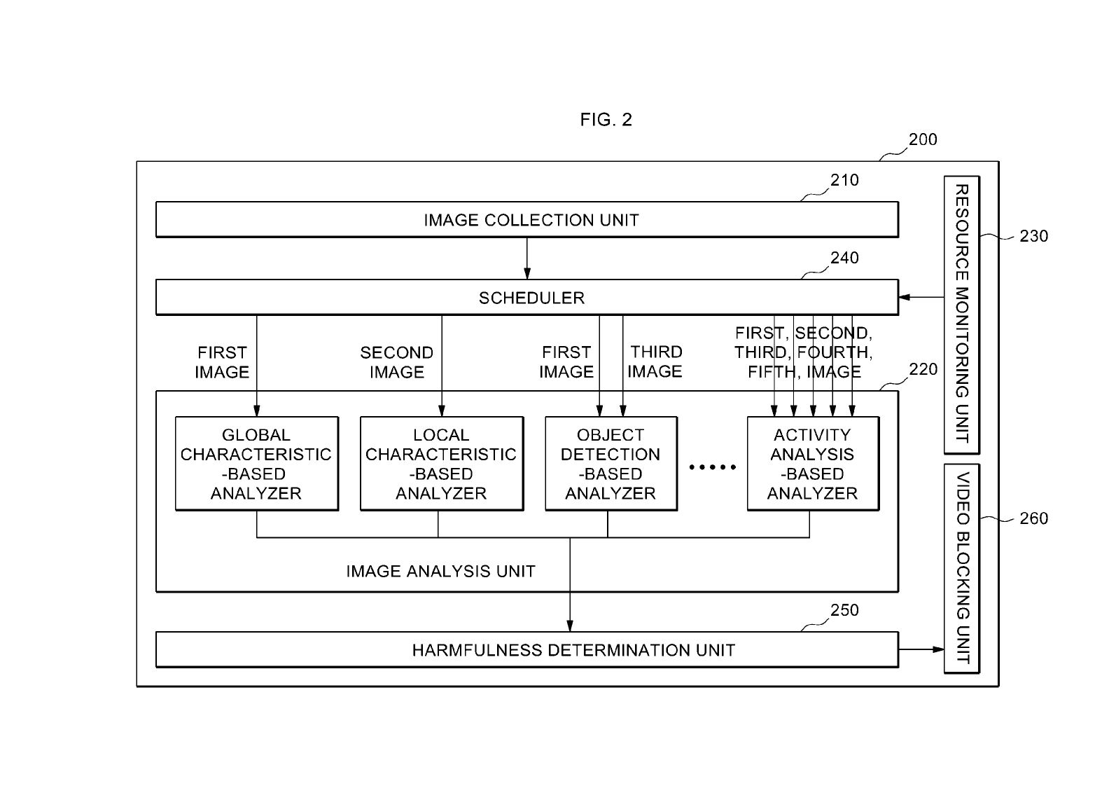

FIG. 2 is a block diagram illustrating an apparatus for detecting a harmful video according to an embodiment of the present invention.

Referring to FIG. 2, an apparatus for detecting a harmful video 200 may include at least one portion or all of an image collection unit 210, an image analysis unit 220, a resource monitoring unit 230, a scheduler 240, a harmfulness determination unit 250, and a video blocking unit 260.

The image collection unit 210 may sample an input video once every predetermined period and collect N (a natural number larger than or equal to 2) image frames.

Further, the image collection unit 210 may collect information related to the video and/or the collected image. Here, the information related to the video and/or the collected image may include play time, frame number, etc.

In an embodiment, the period in which the image frame is collected may be determined based on time or the number of frames.

In an embodiment, the period between sample frame collection and/or the number of the collected image frames N may be changed. For example, the period in which the image frames are collected and/or the number of the collected image frames N may be changed by the scheduler 240.

The image analysis unit 220 may include M (a natural number larger than or equal to 2) analyzers analyzing harmfulness of the image, and each analyzer may extract a different characteristic of the image.

In an embodiment, the image analysis unit 220 may include a local characteristic-based analyzer 221 globally or locally analyzing low level characteristics (for example, color, texture, shape, etc. of the image)/a global characteristic-based analyzer 222, and an analyzer of extracting high level characteristics of the image capable of being analyzed from a plurality of images, for example, various analyzers such as an object detection-based analyzer 223, an activity-based analyzer 224, etc. The amount of operations, the number of image frames needed, accuracy, a required system resource, etc. of each of the analyzers 221 to 224 needed for analyzing different characteristics may be different.

The resource monitoring unit 230 may monitor the resource (for example, a central processing unit (CPU), a memory, a network, a graphic processing unit (GPU), etc.) of the system to which the video inputs, and generate information such as specification grade, current usage ratio, etc. of the system resource.

The scheduler 240 may determine the plurality of analyzers for analyzing the characteristics of N image frames collected by the image analysis unit 220 among the M analyzers, and allocate each of the N image frames to one among the plurality of determined analyzers. For example, as shown in FIG. 2, in the image analysis unit 220, the global characteristic-based analyzer 221, the local characteristic-based analyzer 222, the object detection-based analyzer 223, and the activity-based analyzer 224 may be determined as the analyzers for analyzing the N image frames, and first and second image frames may be allocated to the analyzer 221, the second image frame may be allocated to the analyzer 222, a third image frame may be allocated to the analyzer 223, the first to fifth image frames may be allocated to the analyzer 224, and thus the harmfulness-related characteristics of the image may be analyzed by the analyzers 221 to 224.

In an embodiment, the scheduler 240 may determine the plurality of analyzers for analyzing the characteristics of the collected N images based on the characteristic (for example, the number of frames needed for analysis, the amount of operations, analysis target's characteristic, etc.) of each analyzer included in the image analysis unit 220.

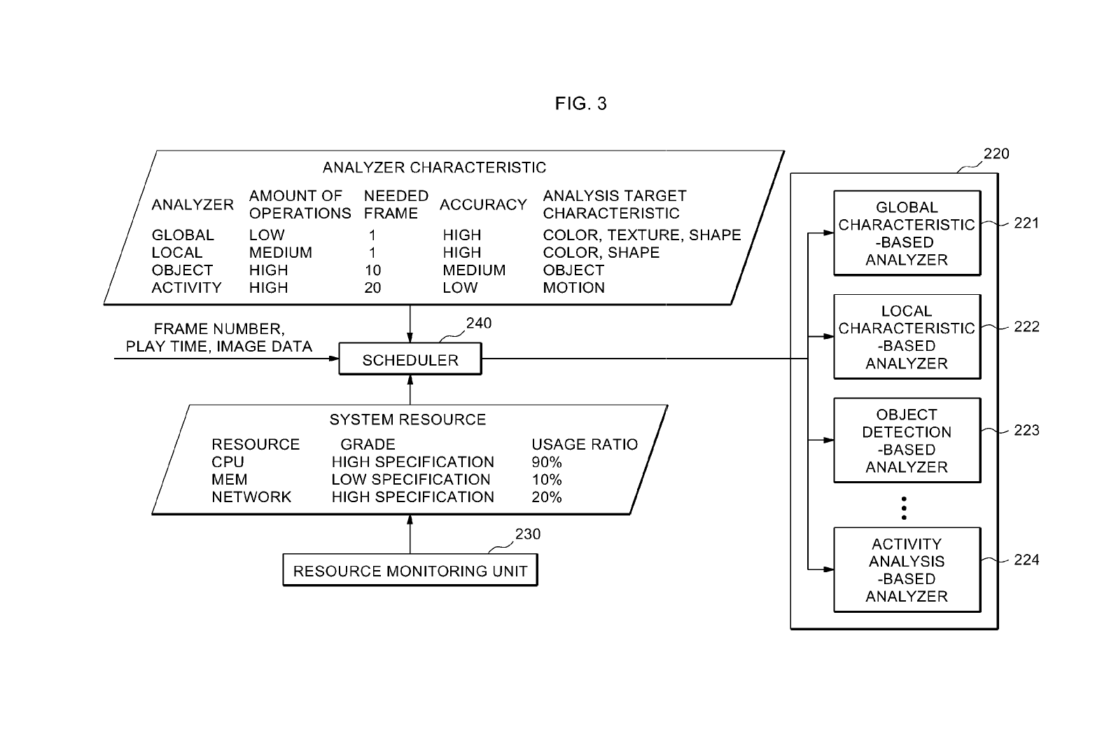

Referring to FIG. 3, an operation determining the analyzer of the scheduler according to an embodiment of the present invention is illustrated. As shown, the scheduler 240 may determine the analyzers 221 to 224 for analyzing the N image frames based on the characteristics of the analyzers, the image information and/or the system resource information.

In an embodiment, the characteristic of the analyzer may include at least one among the amount of operations (for example, high/medium/low) the number of frames needed for analysis (for example, 1, 10, 20, etc.), the analysis accuracy (for example, high/medium/low), the analysis target's characteristics (for example, the color, the texture, the shape, etc.).

In an embodiment, the image information may include frame number, play time, image data, etc.

In an embodiment, the system resource information may be information generated as a monitoring result by the resource monitoring unit 230 and include the grade of each resource, and the current usage ratio, etc.

In an embodiment, the scheduler 240 may change the predetermined period of the image collection unit 210 and/or the number of image frames N to be collected based on the system resource information monitored by the system resource monitoring unit 230.

Referring to FIG. 2 again, the harmfulness determination unit 250 may integrate the analysis results of the plurality of analyzers analyzing the N image frames, and determine the harmfulness of the video. As a result, even though an analyzer is selectively applied to each of the N image frames, a similar harmfulness determination result may be obtained in both the case of integrating the analysis result on each of the N image frames along the time axis and the case of simultaneously applying the plurality of analyzers to one image frame.

The video blocking unit 260 may block the video determined to be harmful by the harmfulness determination unit 250.

In an embodiment, the video blocking unit 260 may suspend and end the play of the video when it is determined by the harmfulness determination unit 250 that the video which is played by the real time streaming service is harmful.

In an embodiment, the video blocking unit 260 may skip the video in the first period and play the video in the second period when it is determined that the video in a predetermined first period is harmful and the video in a predetermined second period is not harmful.

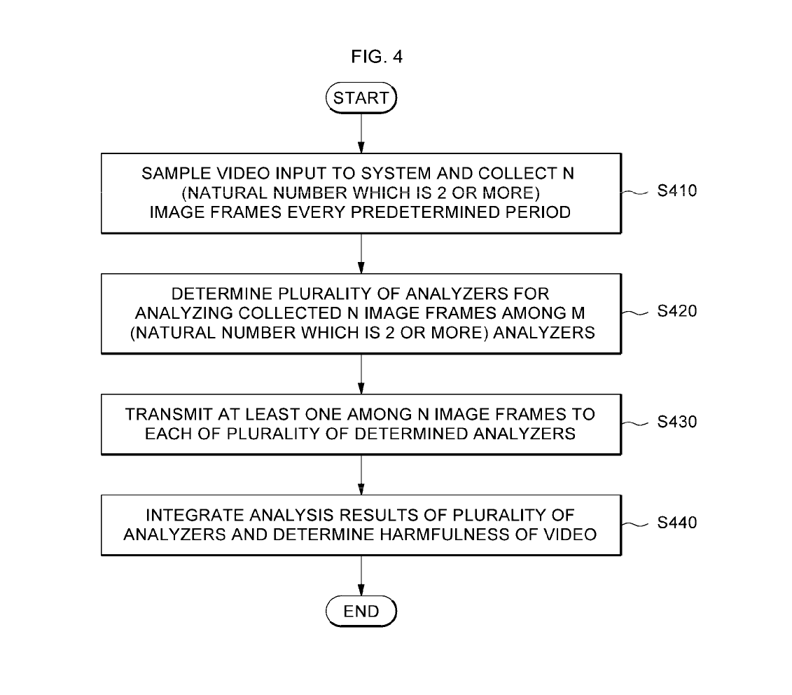

FIG. 4 is a flowchart for describing a method of detecting a harmful video according to an embodiment of the present invention.

In operation S410, the N (a natural number larger than or equal to 2) image frames may be collected every predetermined period by sampling the input video into the system. Here, the predetermined period may be set as a predetermined time or the number of frames.

In operation S420, the plurality of analyzers for analyzing the collected N image frames among the M (an integer larger than or equal to 2) analyzers for analyzing different characteristics of the images may be determined in order to determine the harmfulness of the video.

In an embodiment, the plurality of analyzers for analyzing the N image frames may be determined based on the characteristic (for example, the amount of operations, the number of image (frames) needed for analysis, the analysis accuracy, the analysis target's characteristic, etc.) of each analyzer.

In an embodiment, the plurality of analyzers for analyzing the N image frames may be determined based on the video and at least one piece of the information related to the collected N images.

In an embodiment, the resource of the system into which the video is input may be monitored, and the plurality of analyzers may be determined based on the system resource information (for example, the grade of each resource and the current usage) generated as the monitoring result.

In operation S430, the harmfulness-related characteristics of the N image frames may be analyzed by the plurality of analyzers by allocating at least one among the N image frames to each of the plurality of determined analyzers.

In an embodiment, the plurality of analyzers may include the global characteristic-based analyzer/the local characteristic-based analyzer which globally or locally analyze the low level characteristic (for example, color, texture, shape, etc.) of the image and an analyzer extracting the high level characteristics of the image capable of being analyzed from the plurality of images, for example, various analyzers such as the object detection-based analyzer, the activity-based analyzer, etc.

In operation S440, the harmfulness of the video may be determined by integrating the analysis results of the plurality of analyzers. The video determined to be harmful may be blocked. For example, the video which is currently playing may be suspended, and the video determined to be harmful may become impossible to play.

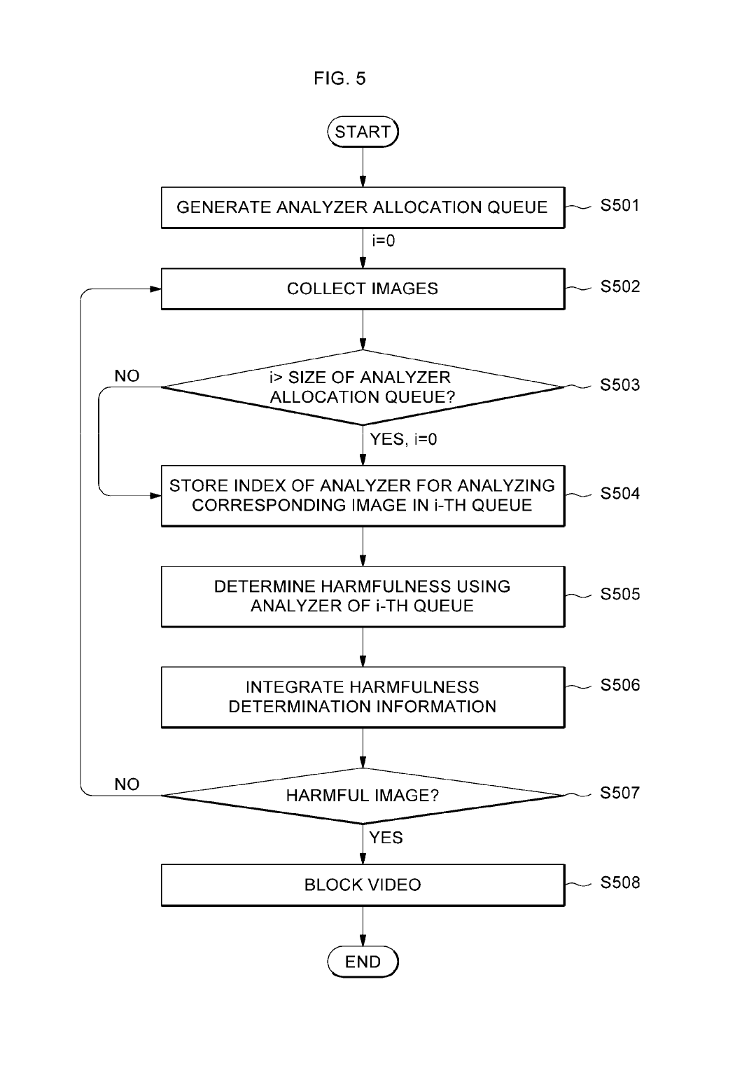

FIG. 5 is a flowchart for describing a method of determining the harmfulness of a video by scheduling the analyzer based on a round-robin method according to one embodiment of the present invention. The round-robin method may be a method of performing the operation cyclically when M tasks exist, and in the present invention, the M analyzers may operate cyclically. Alternatively, when the importance for each analyzer is known, the analyzers may be operated in the round-robin method in the group after generating the analyzer group according to the importance.

Referring to FIG. 5, each of the M analyzers may recognize the number of image frames needed for analyzing the characteristic of the image, and generate an analyzer allocation queue based on the number of recognized image frames (S501).

The image frame may be collected in operation S502, and an index of the analyzer for analyzing a corresponding image frame may be stored in the analyzer allocation queue until the number of image frames does not exceed a size of the analyzer allocation queue (S503, S504). In this case, the index of the analyzer may be determined by the round-robin method. For example, when each of the analyzers A, B, and C needs one image frame for analyzing the characteristic of the image, <A, B, C> may be stored in a corresponding queue. In another example, <C, A, B, C> may be stored in the analyzer allocation queue when the analyzer A and the analyzer B need one image frame but the analyzer C needs two image frames. When the images corresponding to the size of the analyzer allocation queue are collected, the harmfulness on each of the collected images may be analyzed using the analyzer corresponding to the analyzer index number stored in the analyzer allocation queue (S505). In operation S506, the harmful information of each analyzer may be integrated, and in operation S507, the harmfulness of the video may be finally determined. When it is determined that the video is harmful, the corresponding video may be blocked (S508). When it is impossible to determine the harmfulness of the video, the images may continue to be collected and analyzed. That is, operations S502 to S507 may be repeated when the video play is completed.

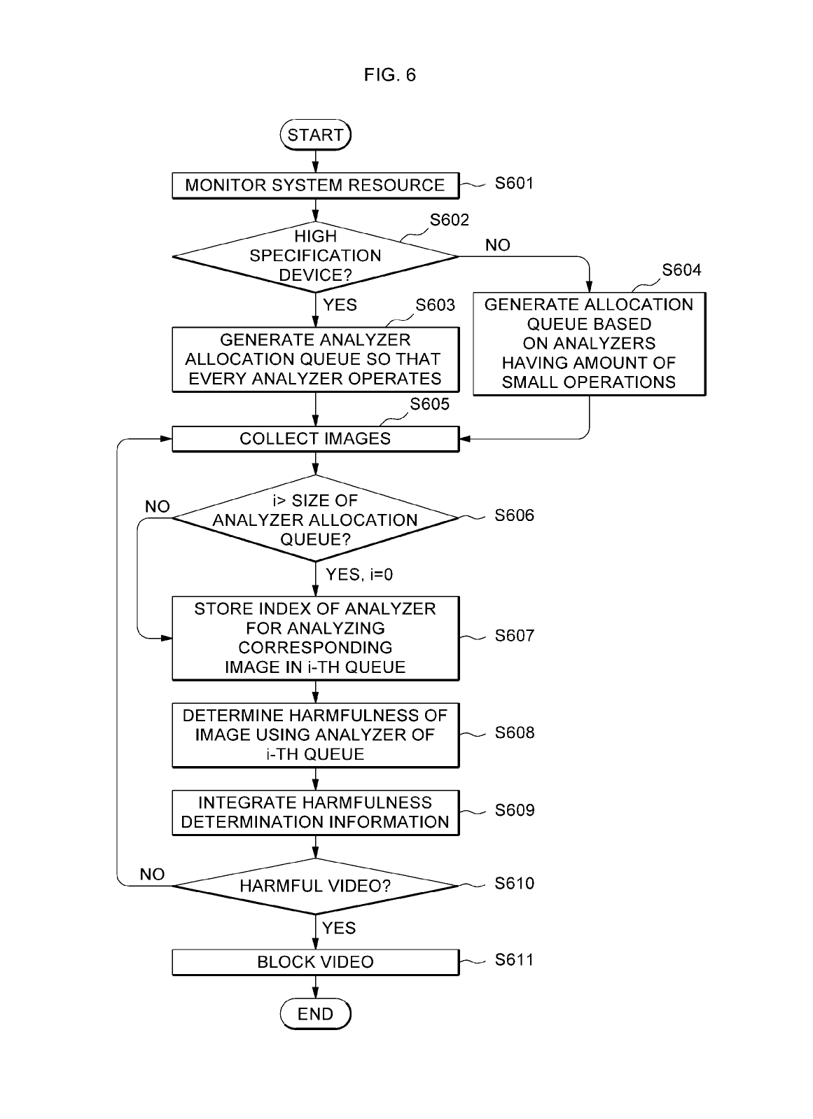

FIG. 6 is a flowchart for describing a method of determining harmfulness of a video by scheduling analyzers based on a result of monitoring a system resource according to another embodiment of the present invention.

As shown, in operation S601, information related to the operation processing capability of the system resource may be collected by monitoring the resource of the system into which the video is input.

In operation S602, it may be determined whether or not the operation processing capability of the system is that of a high capability specification based on the monitoring result of the system resource. When the operation processing capability of the system is that of a high capability specification, an analyzer allocation queue may be generated so that every analyzer operates since there is no problem for using the plurality of analyzers (S603). Meanwhile, when the system resource is not that of the high capability specification capable of operating every analyzer, the analyzer allocation queue may be generated based on the analyzers having the amount of small operations (S604). Hereinafter, since operations S605 to S611 correspond to operations S502 to S508, a detailed description will be omitted.

According to the scheduling method of the analyzer, since the analyzers are selectively used according to the specification of the system, an intermittent disruption of the streaming image reproduction or a slowdown of the system due to the harmful video analysis may be prevented.

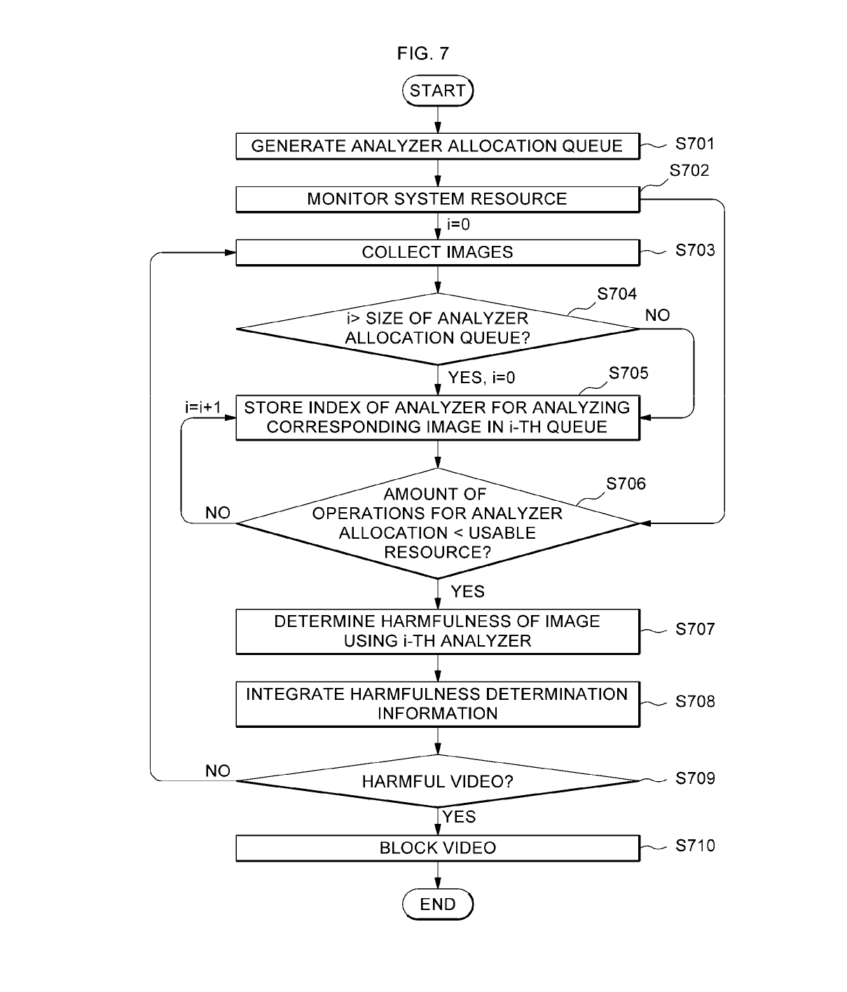

FIG. 7 is a flowchart for describing a method of determining harmfulness of a video by scheduling analyzers based on a system resource which is usable in real time, according to still another embodiment of the present invention.

As shown, each of the M analyzers may recognize the number of image frames needed for analyzing the characteristic of the image, and generate the analyzer allocation queue based on the number of recognized frames (S701).

After this, the resource of the system may be monitored, and the grade on the operation processing capability of the system may be determined (S702).

After this, when the images are collected (S703), the index of the analyzer for analyzing the corresponding image may be stored in the analyzer allocation queue as long as the number of image frames does not exceed the size of the analyzer allocation queue (S704, S705), the amount of operations required by the analyzer and the currently useable resource may be compared (S706), and when the amount of operations required by the analyzer is small, the harmfulness of the image may be determined using the corresponding analyzer (S707).

On the other hand, when the amount of operations required by the analyzer is greater than the usable system resource, the image analysis may not be allocated to the current analyzer, and be determined to allocate to the next analyzer by proceeding to the operation (S705). Hereinafter, since operations S707 to S710 correspond to operations S506 to S508, a detailed description will be omitted.

According to the method described above, since the analyzers are selectively used according to the usage amount of resources of the current system, the overhead on the system due to the harmful video analysis may be reduced.

The apparatus and method according to an embodiment of the present invention may be recorded in a computer readable medium by being implemented as a program command type which is executable through various computer means. The computer readable medium may include a program command, a data file, a data structure, etc. alone or in combination. The program command recorded in the computer readable medium may be specially designed and configured for the present invention, or may be a command which is well known and used by those of ordinary skill in the computer software field. Examples of the storage medium may be a hardware device which is specially configured to store and execute the program command including a magnetic medium such as a hard disk, a floppy disk, and a magnetic tape, an optical recording medium such as a compact disc-read only memory (CD-ROM) and a digital video disc (DVD), a magneto-optical medium such as a floptical disk, a read only memory (ROM), a random access memory (RAM), or a flash memory. In addition, the medium may be a transmission medium such as optical or metallic lines, waveguides including a carrier waver transmitting signals specifying the program command, a data structure, etc. Examples of the program command may include a device which electronically processes information using an interpreter, etc, for example, high-level language codes which are executable by a computer, as well as machine codes which are made by a compiler.

According to an embodiment of the present invention, the harmful video may be effectively detected even in a smart terminal having low processing capability by reflecting the overlapping characteristic of the continuously input streaming video data and selectively applying one among the plurality of analyzers every video image. Image unit processing performance may be increased by selectively applying instead of uniformly applying the plurality of analyzers having different analysis characteristics to every video image, and an analysis performance similar to the case of uniformly applying the analyzers to every image may be obtained by integrating the analysis results on the time axis and analyzing the harmfulness of the streaming video.

The present invention is described based on the above-described exemplary embodiments. It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An apparatus for detecting a harmful video, comprising:
an image collection unit configured to sample a video which is input, and collect N image frames (a natural number larger than or equal to 2) every predetermined period;
an image analysis unit including M (a natural number larger than or equal to 2) analyzers, each analyzer analyzing a different characteristic of an image for determining harmfulness of the video;
a scheduler configured to determine a plurality of analyzers for analyzing the collected N image frames among the M analyzers, and allocate at least one among the N image frames to each of the plurality of determined analyzers; and
a harmfulness determination unit configured to integrate analysis results of the plurality of determined analyzers, and determine the harmfulness of the video.

2. The apparatus for detecting the harmful video of claim 1, further comprising:
a blocking unit configured to block the video determined to be harmful by the harmfulness determination unit.

3. The apparatus for detecting the harmful video of claim 1, wherein the predetermined period is set as a time or the number of frames.

4. The apparatus for detecting the harmful video of claim 1, wherein the scheduler determines the plurality of analyzers for analyzing the collected N image frames based on the characteristic of each analyzer.

5. The apparatus for detecting the harmful video of claim 1, wherein the scheduler determines the plurality of analyzers for analyzing the collected N image frames based on the video and at least one piece of information related to the collected N image frames.

6. The apparatus for detecting the harmful video of claim 1, further comprising:
a resource monitoring unit configured to monitor the resource of a system into which the video is input.

7. The apparatus for detecting the harmful video of claim 6, wherein the scheduler determines the plurality of analyzers for analyzing characteristics of the collected N image frames based on the monitoring result of the resource of the system.

8. A method for detecting a harmful video, comprising:
sampling a video, and collecting N image frames (a natural number larger than or equal to 2) every predetermined period;
determining a plurality of analyzers for analyzing the collected N image frames among M (a natural number larger than or equal to 2) analyzers, each analyzer analyzing a different characteristic of an image for determining the harmfulness of the video;
allocating at least one among the N image frames to each of the plurality of determined analyzers; and
integrating analysis results of the plurality of determined analyzers, and determining the harmfulness of the video.

9. The method for detecting the harmful video of claim 8, further comprising:
blocking the video when the video is determined to be the harmful.

10. The method for detecting the harmful video of claim 8, wherein the predetermined period is set as a time or the number of frames.

11. The method for detecting the harmful video of claim 8, wherein the plurality of analyzers for analyzing the collected N image frames are determined based on a characteristic of each analyzer.

12. The method for detecting the harmful video of claim 8, wherein the plurality of analyzers for analyzing the collected N image frames are determined based on the video and at least one piece of information related to the collected N image frames.

13. The method for detecting the harmful video of claim 8, further comprising:
monitoring the resource of a system into which the video is input.

14. The method for detecting the harmful video of claim 13, wherein the plurality of analyzers for analyzing characteristics of the collected N image frames are determined based on the monitoring result of the resource of the system.
